(19) United States
(12) Patent Application Publication
(10) Pub. No.: US 2009/0229180 A1
(43) Pub. Date: Sep. 17, 2009

(54) Plant stand with rotating trivet and saucer

(76) Inventors: Christopher T. Rich, Leola, PA (US); Edward J. Holliday, Lititz, PA (US); Curt Rymer, Bend, OR (US)

Correspondence Address: JACOBSON HOLMAN PLLC, 400 SEVENTH STREET N.W., SUITE 600, WASHINGTON, DC, 20004, US

(21) Appl. No.: 12/076,091

(22) Filed: Mar. 13, 2008

(51) Int. Cl. A01G 9/02; A01G 9/04; A47G 7/00

(52) U.S. Cl. 47/66.6; 47/71; 47/39

(57) ABSTRACT

A rotatable plant stand having a trivet assembly and a saucer that is mountable thereon. The trivet assembly includes upper and lower trivet plates joined by an annular plate bearing turntable that provides rotational movement of the upper trivet plate relative to the lower trivet plate. The trivet assembly and the saucer are engaged by a centering and retaining mechanism that can secure the bottom of at least two differently sized saucers onto the trivet assembly so as to prevent sideways movement that might otherwise cause the saucer to slide off the trivet assembly, such as when being rotated.

### BACKGROUND OF THE INVENTION

1. Field of the Invention

The present invention is related to the field of horticulture and, more particularly, to a rotatable potted plant stand for indoor and outdoor use.

2. Description of the Related Art

Potted plants are placed in various locations in our homes and offices as well as in outdoor locations such as patios, decks, etc. While the selected location is generally one that gives the plant access to direct sunlight during at least part of the day, the plant nonetheless receives this sunlight from only one direction. This results in greater growth on the sun-facing side so that the plant is seen as leaning or listing to that side.

Potted plant locations can also provide limited access to all portions of the plant, making it difficult to water, spray or prune the plant effectively.

Therefore, a need exists for a plant stand that allows the plant to be easily rotated for varying sun exposure and plant care maintenance while providing a secure supporting surface to the plant.

### SUMMARY OF THE INVENTION

In view of the foregoing, one object of the present invention is to overcome the difficulties of rotating potted plants to provide them with sunlight from more than one direction.

Another object of the present invention is to provide a rotating plant stand assembly that gives the plant a secure supporting surface, both during rotation and while stationary.

Yet another object of the present invention is to provide a rotating plant stand assembly in accordance with the preceding objects that includes a trivet assembly having a plate bearing turntable that allows rotation of the trivet assembly while maintaining sufficient friction to prevent free spinning thereof when rotated.

A further object of the present invention is to provide a rotating plant stand assembly in accordance with the preceding objects that includes a saucer having protrusions that are captured within corresponding pockets formed in the trivet assembly to align and secure the saucer with respect to the trivet assembly.

A still further object of the present invention is to provide a rotating plant stand assembly in accordance with the preceding objects in which the pockets formed in the trivet assembly are sized and spaced to interlock with at least two different sizes of saucers for automatic alignment and self centering of each saucer on the trivet assembly.

Yet a further object of the present invention is to provide a rotating plant stand assembly in accordance with the preceding objects that is not complex in structure and which can be manufactured at low cost but yet efficiently provides a means for easy and stable potted plant rotation.

In accordance with these and other objects, the present invention is directed to a rotatable plant stand having a trivet assembly and a saucer that is mountable thereon. The trivet assembly includes upper and lower trivet plates joined by an annular plate bearing turntable that provides rotational movement of the upper trivet plate relative to the lower trivet plate.

The rotatable plant stand is provided with a centering and retaining mechanism that secures the saucer against sideways movement relative to the trivet assembly. The centering and retaining mechanism includes protrusions on the bottom of the saucer and adjacent an outer perimeter thereof, which mate or nest with either the outer edge of the trivet assembly or one or more pockets formed in the upper surface of the upper trivet plate. In the case of the outer edge, the protrusions on the outer edge of the bottom of the saucer fit down over the outer edge of the trivet assembly to effectively nest the saucer over the trivet assembly. With the pockets, on the other hand, the protrusions on the saucer are received in the pockets to interlock the saucer with the upper surface of the upper trivet plate. Through the interlocking of the saucer protrusions over the outer edge or within the pockets of the trivet assembly, the saucer is centered on the trivet assembly and held against sideways movement that might otherwise cause the saucer to slide off the trivet assembly, particularly when being rotated.

According to one preferred embodiment, the centering and retaining mechanism is configured so as to interlock with the protrusions formed on at least two saucers of different sizes, where each saucer size has a different arrangement of protrusions. This allows the same trivet assembly to be used to support multiple plants of different sizes, each sitting within an appropriately sized saucer.

These advantages, together with other objects and advantages which will become subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows a representative trivet assembly with one size saucer and plant pot in accordance with the present invention.

FIG. 2 is an assembled side view of the trivet assembly and saucer of FIG. 1.

FIG. 3 is a partial cross-sectional view of the assembled trivet assembly and saucer of FIG. 2 taken along line A-A thereof.

FIG. 4 shows the trivet assembly of FIG. 1 with another saucer of a larger size.

FIG. 5 is an assembled side view of the trivet assembly and saucer of FIG. 4.

FIG. 6 is a partial cross-sectional view of the assembled trivet assembly and saucer of FIG. 4 taken along line B-B thereof.

FIG. 7 is an exploded view of a large trivet assembly with plate bearing turntable in accordance with the present invention.

FIG. 8 is an assembled view of the components of FIG. 7.

FIG. 9A is a top perspective view of an upper trivet plate of the trivet assembly of FIG. 7.

FIG. 9B is a top view of the upper trivet plate of FIG. 9A.

FIG. 9C is a side view of the upper trivet plate of FIG. 9A.

FIG. 9D is a bottom view of the upper trivet plate of FIG. 9A.

FIG. 9E is a cross sectional view taken along line A-A of FIG. 9D.

FIG. 10A is a top perspective view of the lower trivet plate of the large trivet assembly of FIG. 7.

FIG. 10B is a top view of the lower trivet plate of FIG. 10A.

FIG. 10C is a cross sectional view taken along line A-A of FIG. 10B.

FIG. 10D is a side view of the lower trivet plate of FIG. 10A.

FIG. 10E is a bottom view of the lower trivet plate of FIG. 10A.

FIG. 11A is a top perspective view of the lower bearing plate of the trivet assembly of FIG. 7.

FIG. 11B is a top view of the lower bearing plate of FIG. 11A.

FIG. 11C is a cross-sectional view taken along line A-A of FIG. 11B.

FIG. 11D is a cross-sectional view taken along line B-B of FIG. 11B.

FIG. 11E is a side view of the lower bearing plate of FIG. 11A.

FIG. 11F is a bottom view of the lower bearing plate of FIG. 11A.

FIG. 12A is a top perspective view of the upper plate of the trivet assembly of FIG. 7.

FIG. 12B is a top view of the upper plate of FIG. 12A.

FIG. 12C is a cross-sectional view taken along line A-A of FIG. 12B.

FIG. 12D is a side view of the upper plate of FIG. 12A.

FIG. 12E is a bottom view of the upper plate of FIG. 12A.

FIG. 13A is a side perspective view of the washer of the trivet assembly of FIG. 7.

FIG. 13B is a top view of the washer of FIG. 13A.

FIG. 13C is a side view of the washer of FIG. 13A.

FIG. 14A is a side perspective view of an assembled plate bearing turntable with washer and upper and lower bearing plates in accordance with the present invention.

FIG. 14B is a top view of the turntable of FIG. 14A.

FIG. 14C is a cross-sectional view taken along line A-A of FIG. 14B.

FIG. 14D is a side view of the turntable of FIG. 14B.

FIG. 14E is a bottom view of the turntable of FIG. 14B.

FIG. 15A is a top perspective view of a rubber foot for use with a trivet assembly in accordance with the present invention.

FIG. 15B is a top view of the foot of FIG. 15A.

FIG. 15C is a side view of the foot of FIG. 15A.

FIG. 15D is a cross-sectional view taken along line A-A of FIG. 15C.

FIG. 15E is a bottom view of the foot of FIG. 15A.

FIG. 16 is an exploded view of a medium trivet assembly with plate bearing in accordance with the present invention.

FIG. 17 is an assembled view of the components of FIG. 16.

FIG. 18 is an exploded view of a small trivet assembly with plate bearing turntable in accordance with the present invention.

FIG. 19 is an assembled view of the components of FIG. 18.

FIG. 20A is a top perspective view of a 6″ saucer configured for use with the trivet assembly of the present invention.

FIG. 20B is a top view of the saucer of FIG. 20A.

FIG. 20C is a side view of the saucer of FIG. 20B.

FIG. 20D is a cross-sectional view taken along line A-A of FIG. 20C.

FIG. 21A is a top perspective view of a 10″ saucer configured for use with the trivet assembly of the present invention.

FIG. 21B is a top view of the saucer of FIG. 21A.

FIG. 21C is a side view of the saucer of FIG. 21B.

FIG. 21D is a cross-sectional view taken along line A-A of FIG. 21C.

FIG. 22A is a top perspective view of a 14″ saucer configured for use with the trivet assembly of the present invention.

FIG. 22B is a top view of the saucer of FIG. 22A.

FIG. 22C is a side view of the saucer of FIG. 22B.

FIG. 22D is a cross-sectional view taken along line A-A of FIG. 22C.

FIG. 23A is a top perspective view of a 16″ saucer configured for use with the trivet assembly of the present invention.

FIG. 23B is a top view of the saucer of FIG. 23A.

FIG. 23C is a side view of the saucer of FIG. 23B.

FIG. 23D is a cross-sectional view taken along line A-A of FIG. 23C.

### DETAILED DESCRIPTION OF THE PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

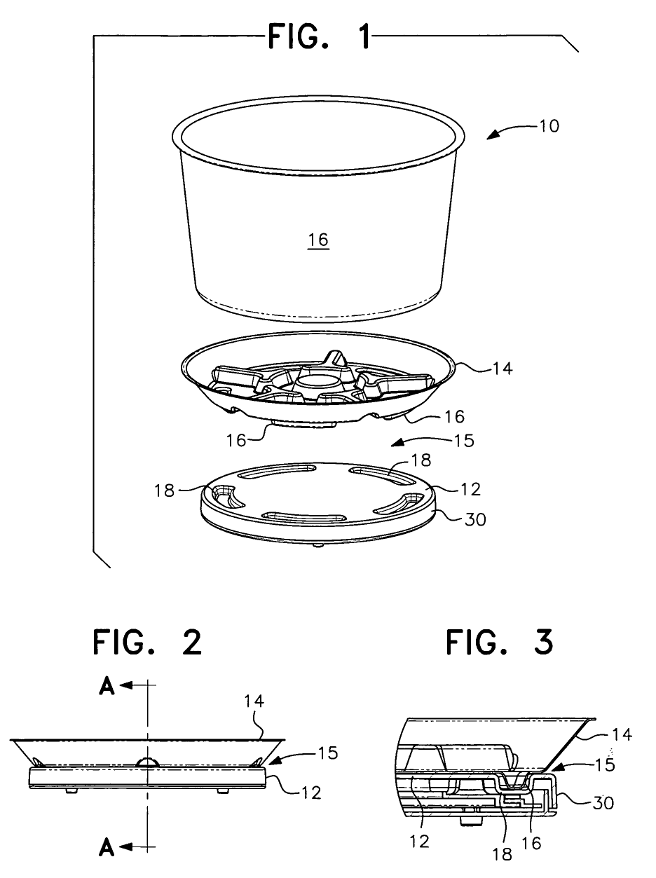

As representatively shown in FIGS. 1-6, the present invention is directed to a rotatable plant stand generally designated by the reference numeral 10. The plant stand includes a trivet assembly 12 and one or more saucers 14, 24 of different sizes that are mountable thereon. The saucer supports a planter 16 that generally contains a potted plant (not shown). The planter 16 is of conventional design and is not considered part of the invention as described herein.

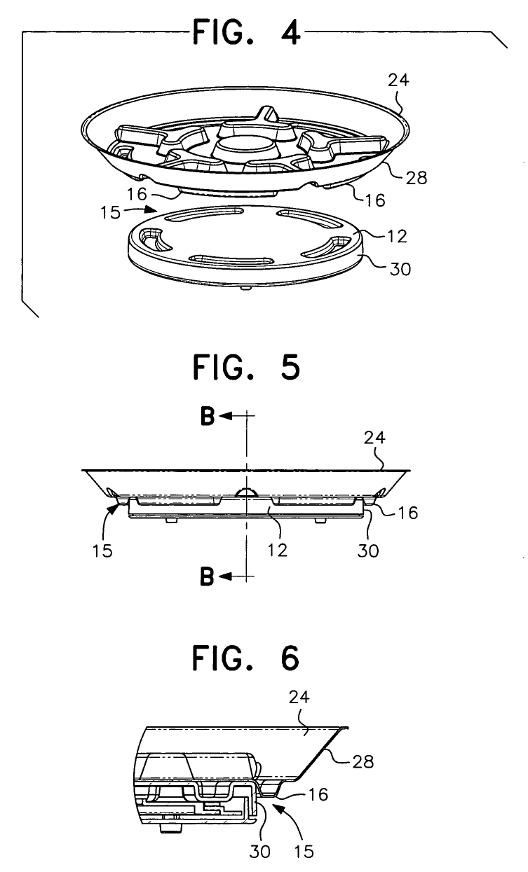

A side view of the saucer 14, 24 as may be mounted on the trivet assembly 12 with a centering and retaining mechanism, generally designated by the reference numeral 15, is shown in FIGS. 1-6. The centering and retaining mechanism 15 secures the saucer 14, 24 against sideways movement relative to the trivet assembly 12 and includes protrusions 16 on the bottom of the saucer adjacent an outer perimeter 28 thereof. The protrusions 16 mate or nest with either the outer edge 30 of the trivet assembly 12 (FIGS. 4-6) or one or more pockets 18 formed in the upper surface of the trivet assembly (FIGS. 1-3). In the case of the outer edge 30, the protrusions 16 adjacent the outer perimeter 28 of the bottom of the saucer fit down over the outer edge 30 to effectively nest the saucer over the trivet assembly. With the pockets 18, on the other hand, the protrusions 16 on the saucer 14 are received in the pockets to interlock the saucer within the upper surface of the trivet assembly. Through the interlocking of the saucer protrusions over the outer edge or within the pockets of the trivet assembly, the saucers 14, 24 which hold planter 16 or other potted plant (not shown), is prevented from moving sideways on the trivet assembly 12.

As above described, the ability to use either the outer edge or upper surface pockets as retaining elements on the trivet assembly allows the same trivet assembly to be used with two different saucer sizes, interchangeably. The manner in which the protrusions 16 on a smaller saucer 14 are received within corresponding pockets 18 formed in the trivet assembly 12 is shown in FIG. 3. Alternatively, the same trivet as interlocked with a larger saucer 24, by engaging the outer edge 30 of the trivet assembly with the protrusions 16, is illustrated in FIGS. 5 and 6.

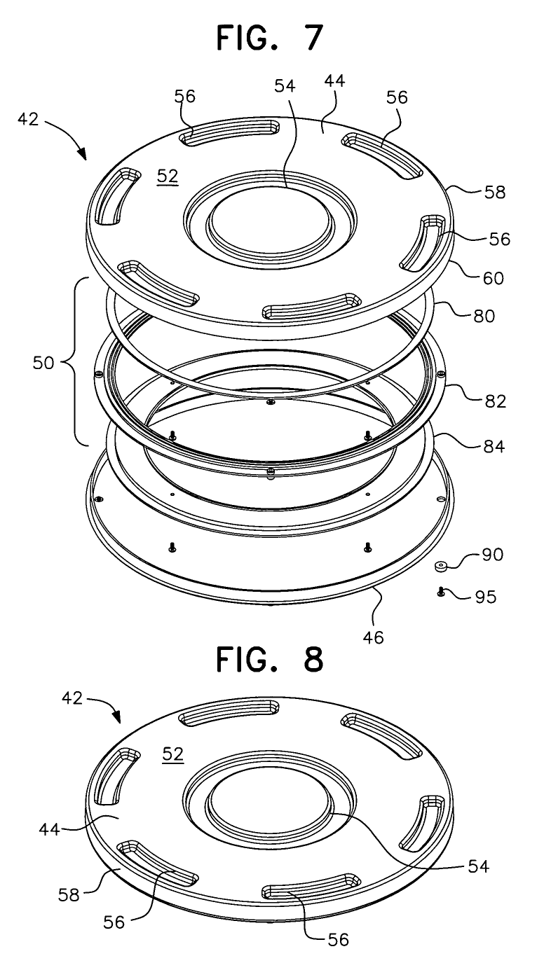

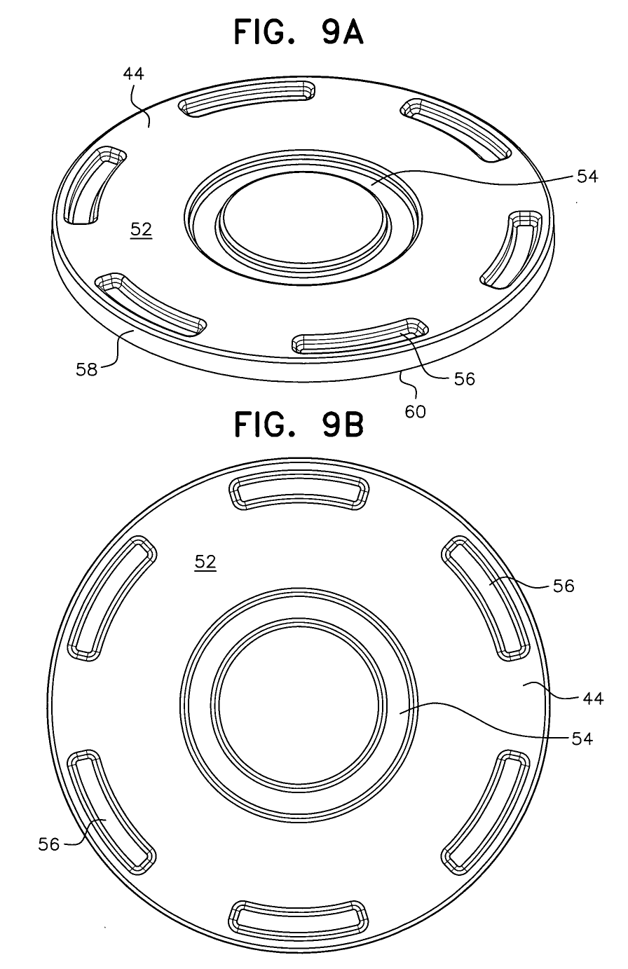

Exploded and assembled views of a large trivet assembly, generally designated by the reference numeral 42, are shown in FIGS. 7 and 8, respectively. The large trivet assembly includes an upper trivet plate 44, a lower trivet plate 46 and an annular plate bearing turntable, generally designated by the reference numeral 50, that provides rotational movement of the upper trivet plate 44 relative to the lower trivet plate 46.

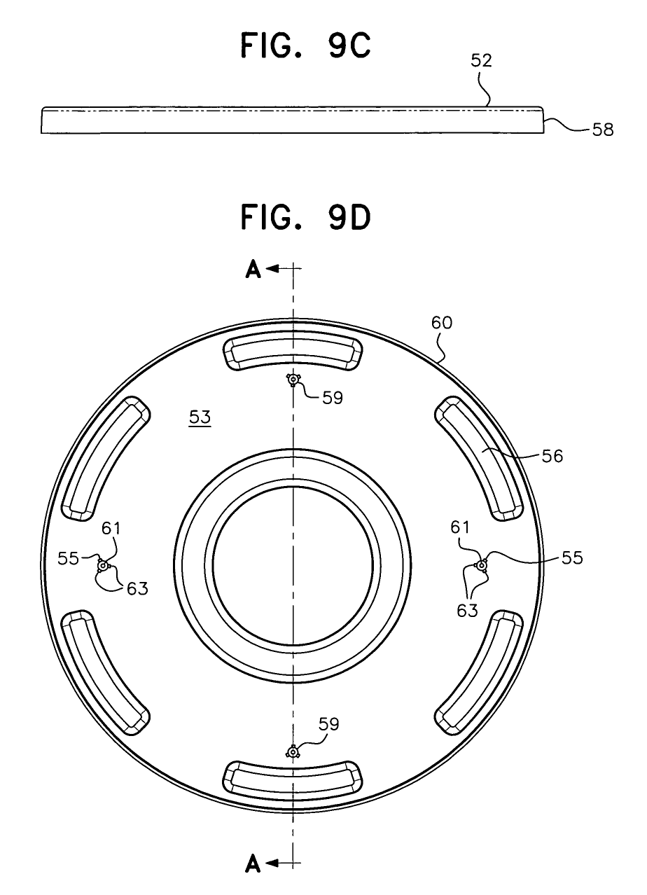

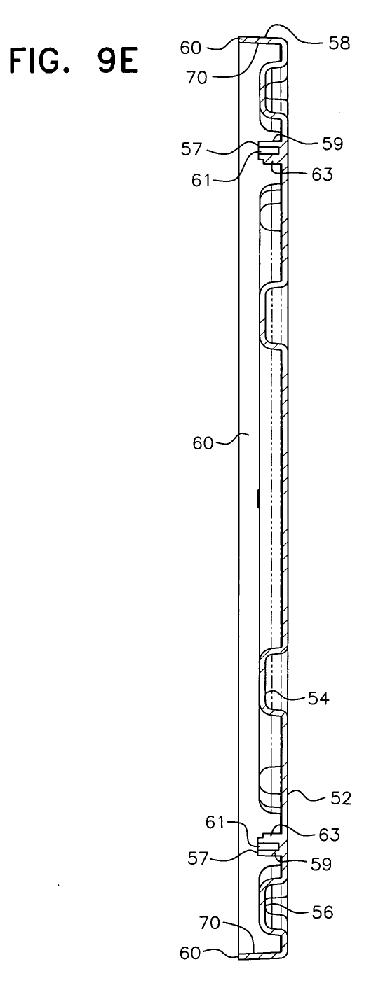

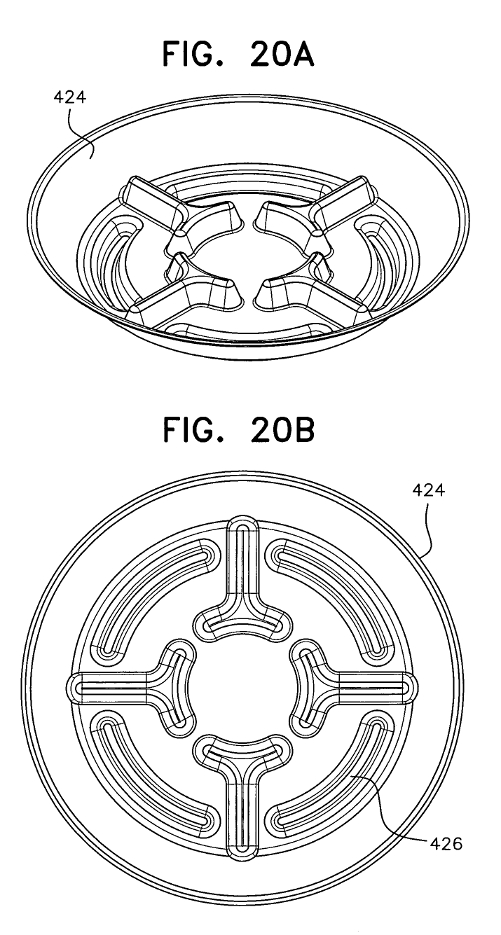

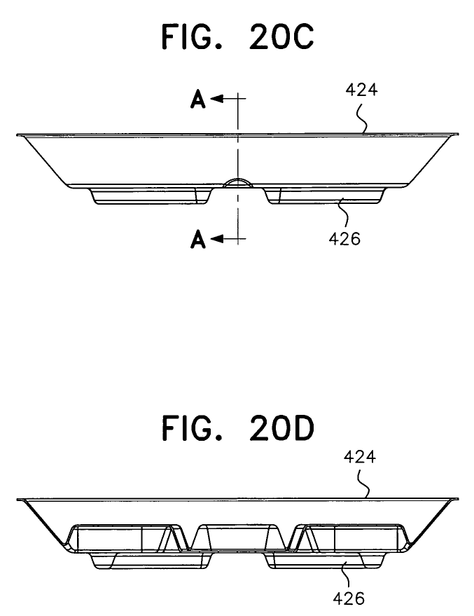

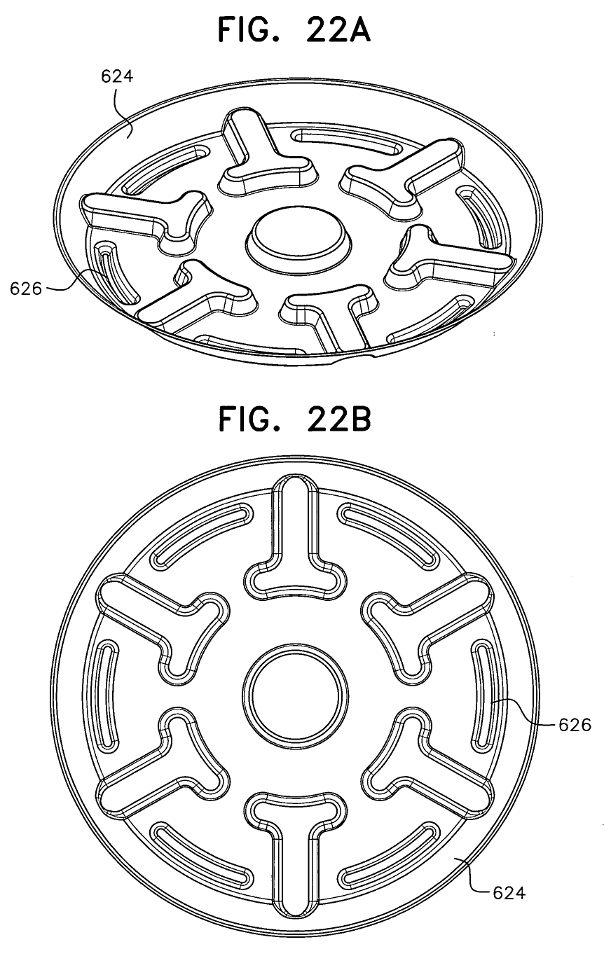

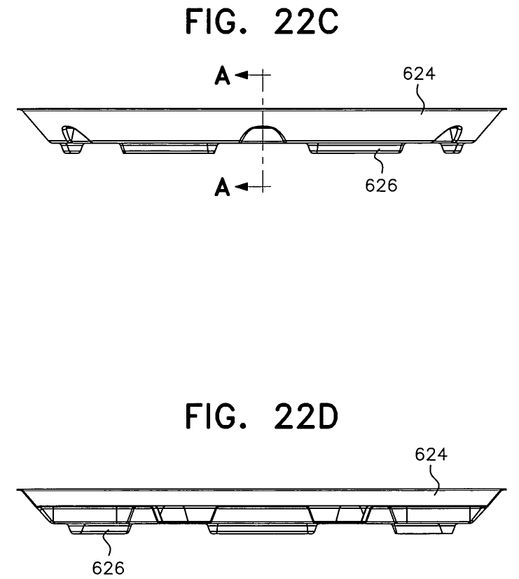

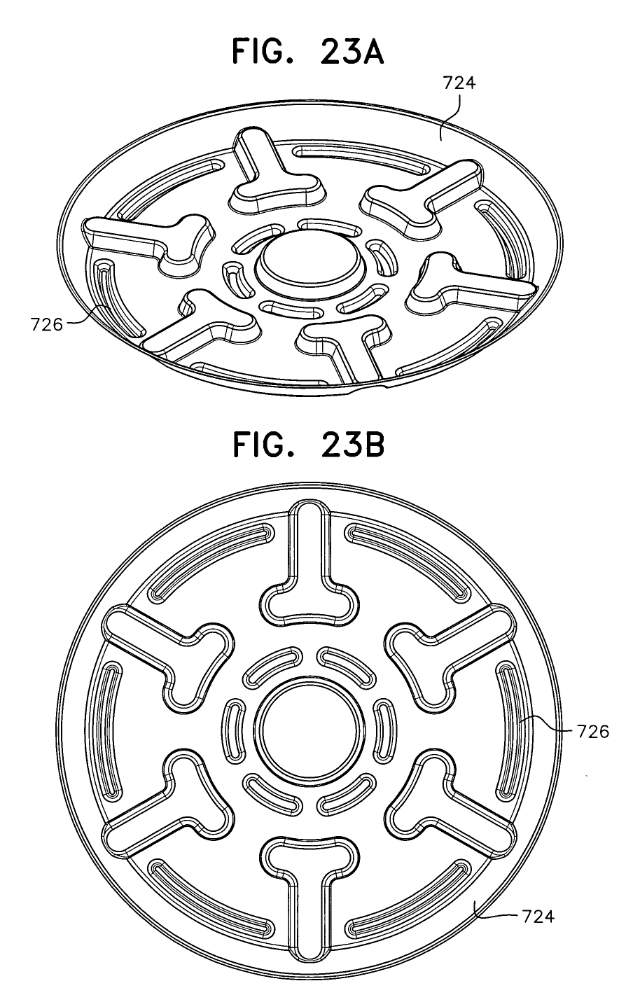

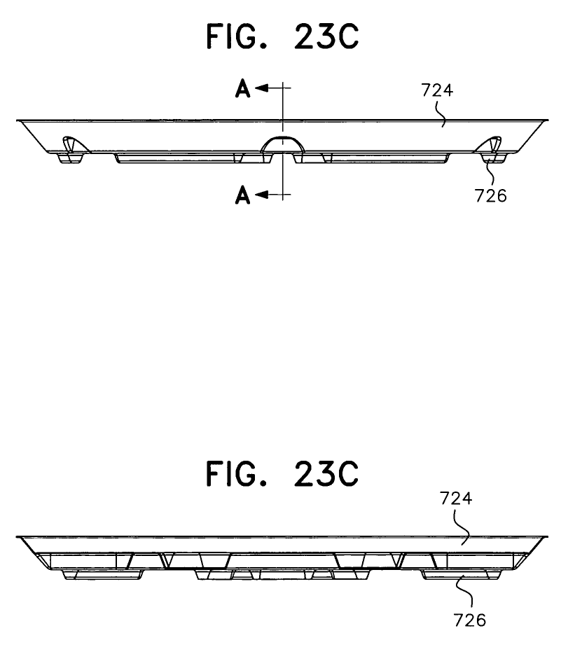

The upper trivet plate 44 of the large trivet assembly 42 is shown in FIGS. 9A-9E and has an upper surface 52, a lower surface 53 and a downwardly directed rim 60 around the perimeter 58 that mates with a complementary structure on the lower trivet plate 46. The upper surface 52 includes an annular channel 54 around the center and a plurality of spaced elongated pockets 56 adjacent the perimeter 58. With this structure, the large trivet assembly 42 can support at least three different saucers having various corresponding protrusions in a nested or interlocked manner. For example, a small saucer having an annular protrusion or a series of spaced curved protrusions such as shown in FIGS. 20A-20D can interlock within the annular channel 54. A medium saucer having a plurality of spaced elongated protrusions (see FIGS. 22A-22D) can be received within the elongated pockets as shown in FIG. 3, and a large saucer having a plurality of spaced elongated protrusions (see FIGS. 23A-23D) can be interlocked with an outer edge of the upper trivet plate 44 as shown in FIGS. 5 and 6. The same trivet assembly can, therefore, be used to safely and securely center and retain multiple saucers of different sizes, according to the user's needs. In a preferred embodiment, these varying saucer sizes can be purchased individually and then used interchangeably while being marketed on a common display to provide the user with a full selection of plant support options.

The lower surface 53 of the upper trivet plate 44 has a plurality of downwardly projecting bosses 55 in spaced relationship with one another as shown in FIGS. 9D and 9E. The bosses 55 each have a substantially flat top 57, a generally cylindrical outer wall 59, and a blind threaded bore 61 for receiving a fastening element, such as a screw. The cylindrical outer wall 59 of each boss 55 has a plurality of spaced webs 63 that extend longitudinally from the lower surface 53 of the plate 44 toward, but short of, the flat top 57 of the boss 55.

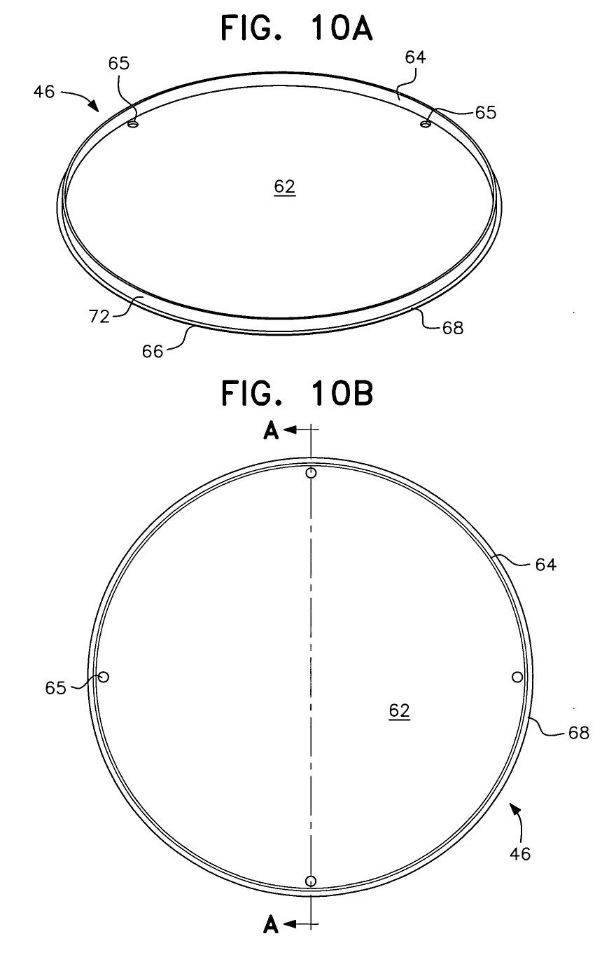

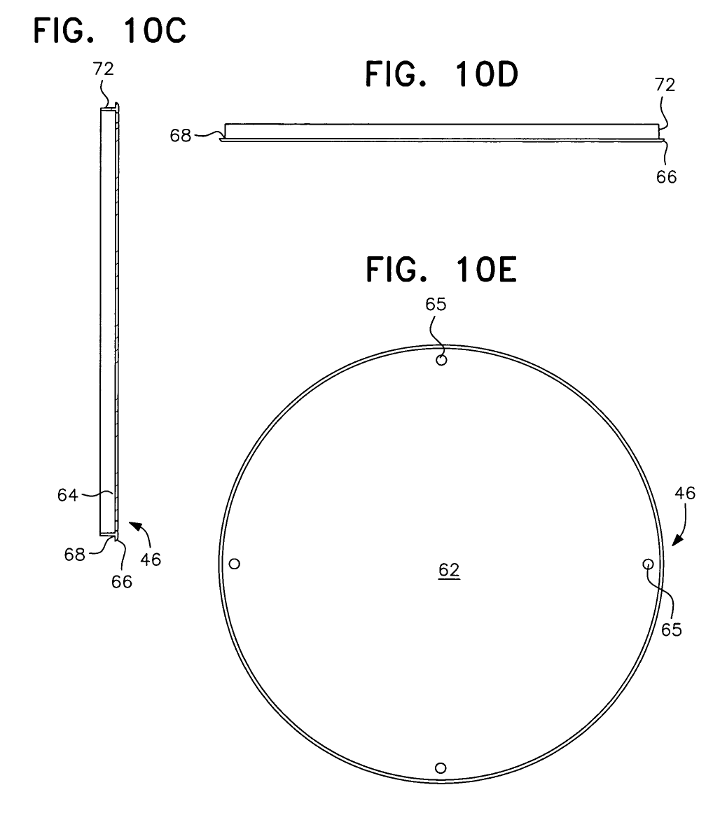

The lower trivet plate 46 of the large trivet assembly 42 is shown in FIGS. 10A-10E and includes a flat disc 62 having a plurality of apertures 65 for receiving fastening elements such as screws 95, and an upwardly extending annular rim 64 close to, but spaced from, the perimeter 66 of the disc 62 so as to define a disc perimeter flange 68. The downwardly directed rim 60 of the upper trivet plate 44 fits down over the annular rim 64 on the lower trivet plate 46, bringing the inner surface 70 of the rim 60 against the outer surface 72 of the rim 64. When fully nested, the rim 60 comes into abutment with or close proximity to the flange 68 when the trivet is assembled.

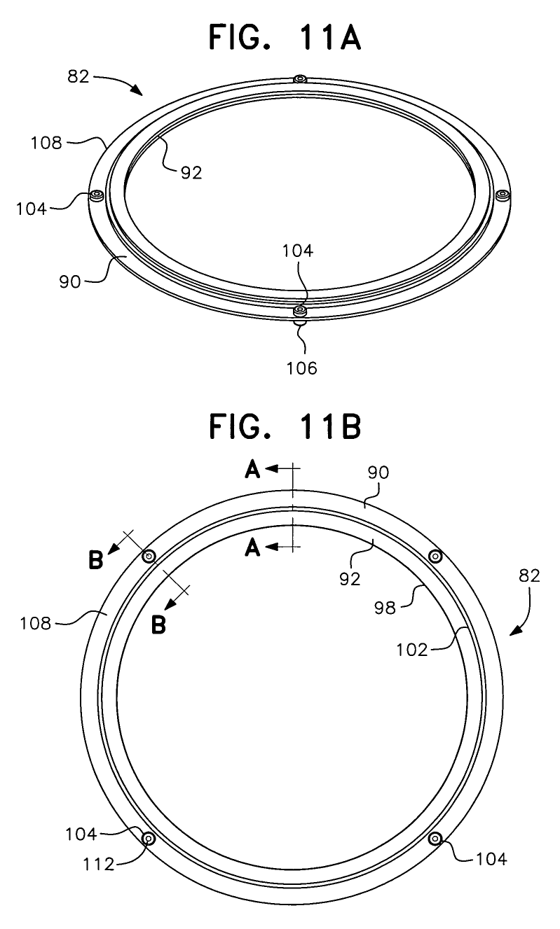

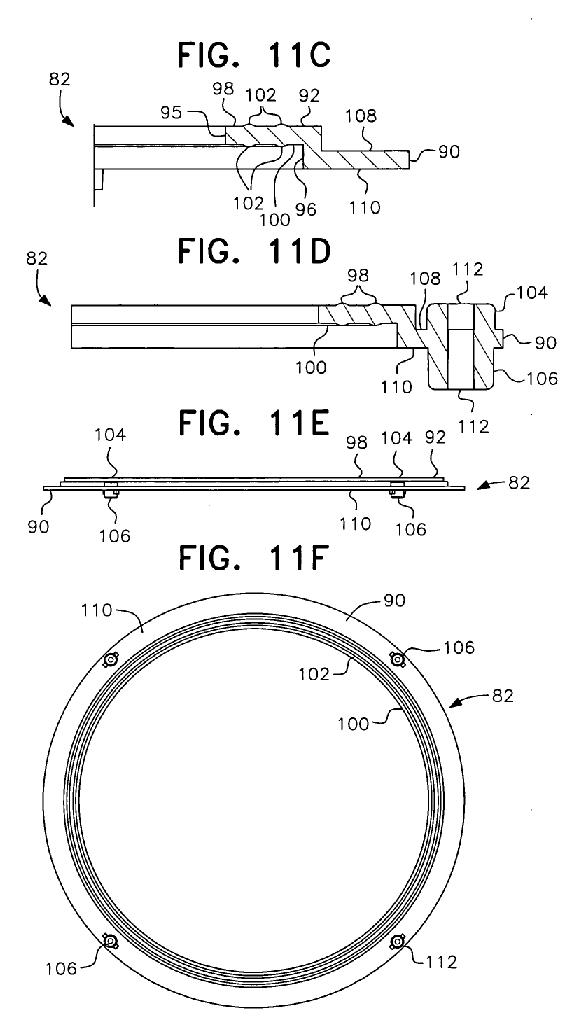

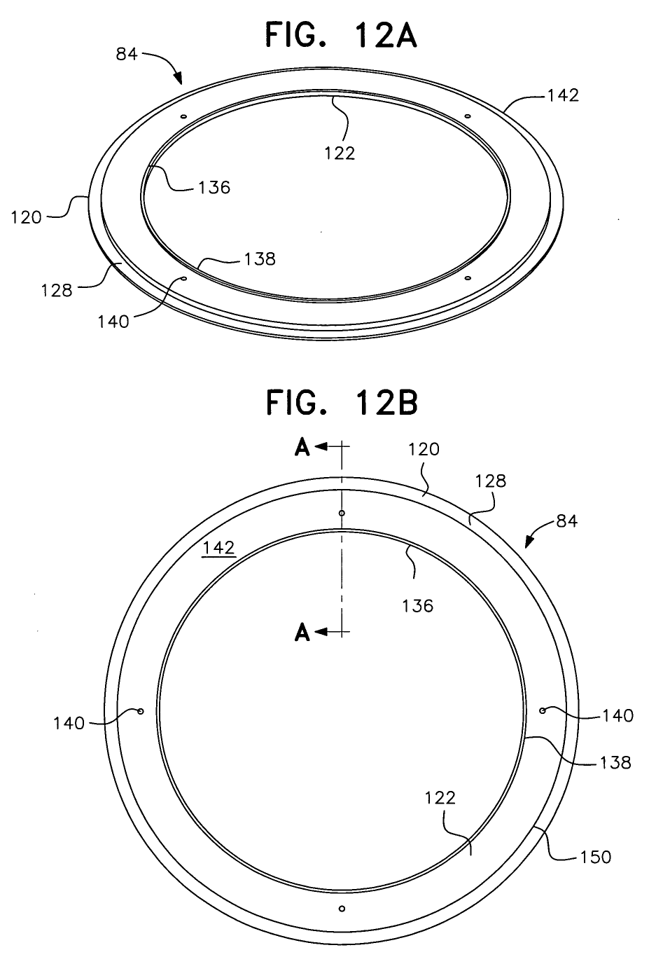

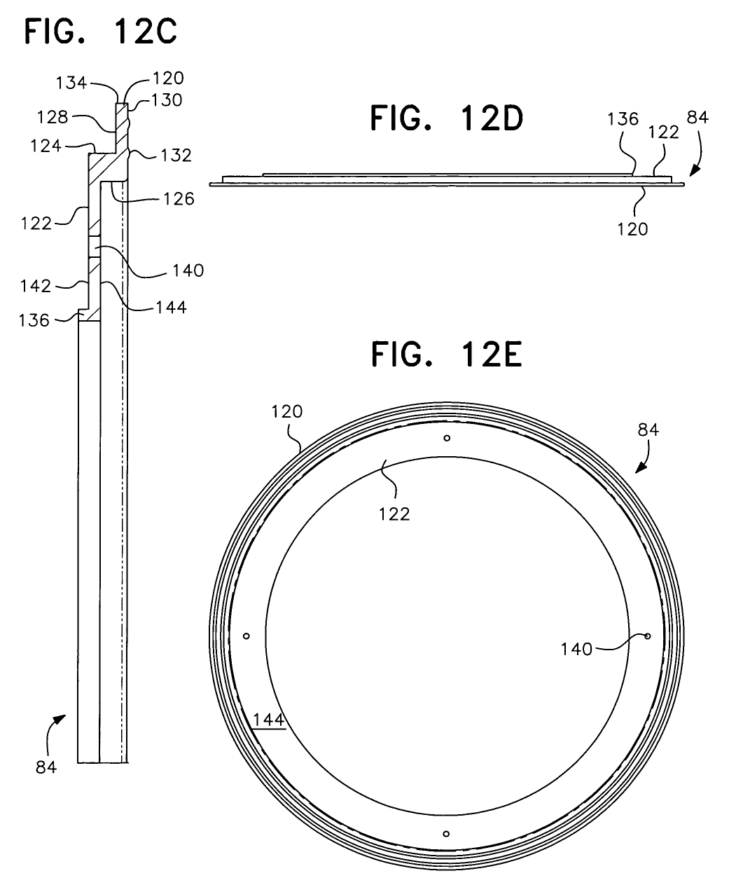

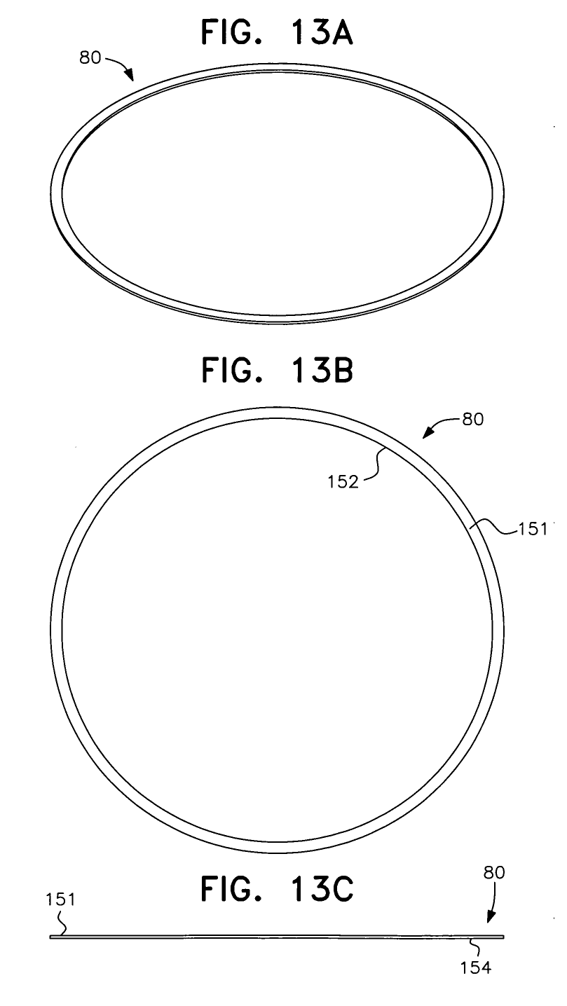

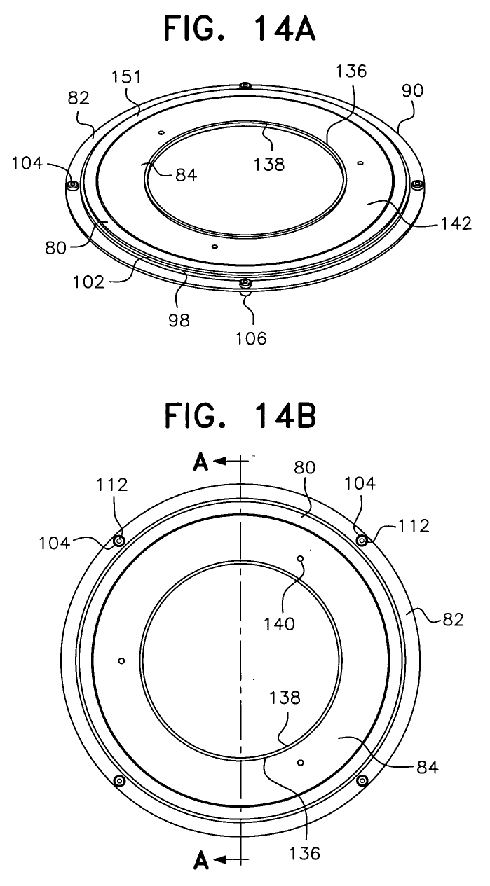

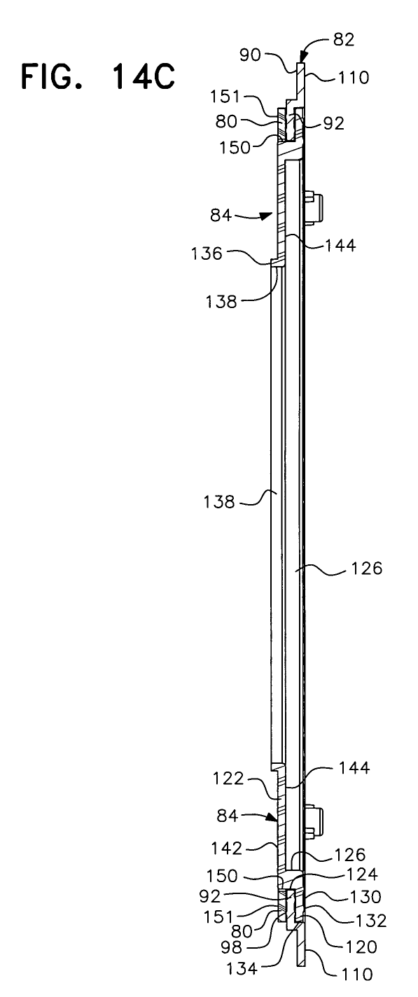

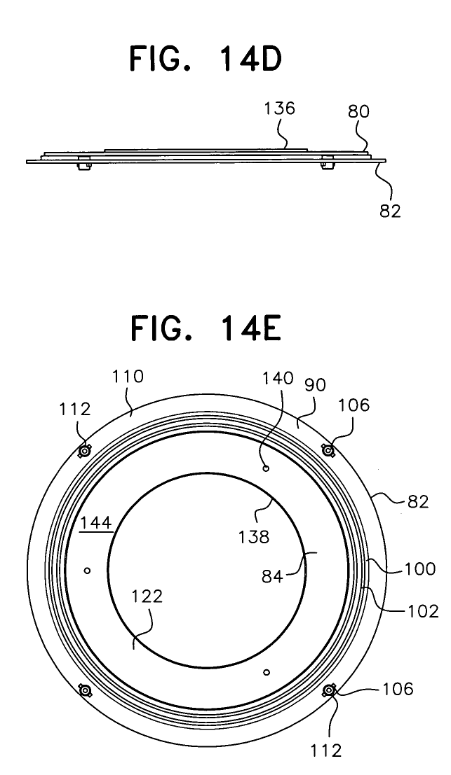

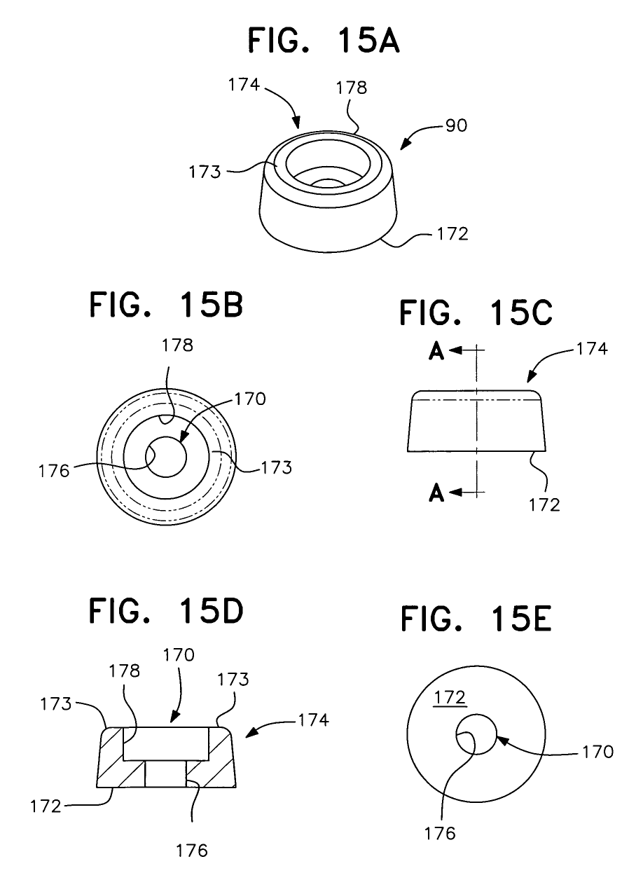

The annular plate bearing turntable 50 fits between the upper and lower trivet plates 44, 46. The turntable 50 includes: a lower bearing plate, generally designated by the reference numeral 82, as shown in FIGS. 11A-11F; an upper bearing plate, generally designated by the reference numeral 84, as shown in FIGS. 12A-12E, that has an interfitting relationship with said lower bearing plate; and a washer, generally designated by the reference numeral 80, as shown in FIGS. 13A-13C. The plate bearing turntable with the interfitting lower and upper bearing plates 82, 84 and washer 80, as assembled, is shown in various views in FIGS. 14A through 14E.

The lower bearing plate 82 includes a perimeter ring 90 and an inner ring 92 that are preferably integral with one another and formed of molded plastic. The inner ring 92 is raised with respect to the perimeter ring 90 and overlaps therewith such that the outer diameter 94 of the inner ring 92 is larger than the inner diameter 96 of the perimeter ring 90 (see FIG. 14C). Both the upper surface 98 and the lower surface 100 of the inner ring 92 are provided with one or more annular ribs 102 that are concentric with the perimeter ring 90. According to one preferred embodiment, there are two ribs 102 on each of the upper and lower surfaces 98, 100 that are spaced from one another and from the edges defining the inner diameter 95 and outer diameter 94 of the inner ring 92. The annular ribs 102 on the lower surface 100 provide a reduced bearing surface that facilitates relative movement between the two interfitting plates 82, 84, while the annular ribs 102 on the upper surface 98 reduce the contact area with the washer 80 to reduce frictional resistance with the upper trivet plate. The size and shape of the ribs, which are preferably formed integrally with the plate 82, can be adjusted during manufacture to either decrease or increase the contact area and hence the amount of friction between the lower bearing plate 82 and the upper plate 84, in turn either facilitating ease of rotation or making rotation more difficult.

The perimeter ring 90 has upwardly and downwardly projecting bosses 104, 106 on its upper and lower surfaces 108, 110, respectively, that are aligned in respective pairs. Each aligned pair of bosses is provided with a bore 112 that passes through the perimeter ring 90 and is threaded to receive a fastening element, such as a screw 95. The bosses are preferably integral with the lower bearing plate and formed of molded plastic.

Like the lower bearing plate 82, the upper plate 84 includes a perimeter ring 120 and an inner ring 122. The inner ring 122 is raised with respect to the perimeter ring 120 and overlapping therewith such that the outer diameter 124 of the inner ring 122 is larger than the inner diameter 126 of the perimeter ring 120 (see FIG. 14C).

The lower surface 130 of the perimeter ring 120 is provided with one or more annular ribs 132 that are concentric with an outer edge 134 of the perimeter ring 120 and spaced therefrom. According to one preferred embodiment, there are two ribs 132 in a spaced relationship on the lower surface 130. The annular ribs 132 on the upper plate 84 provide a reduced bearing surface that facilitates relative movement between the two interfitting plates 82, 84 by reducing friction between the bottom of the upper bearing plate and the inner surface of the lower trivet plate. As with the ribs on the lower bearing plate, changes can be made in the size and shape of the ribs during manufacture to either decrease or increase the contact area and hence the amount of friction between the contact surfaces.

As would be understood by persons of ordinary skill in the art, the desired size, shape and number of the ribs is also determined by the material from which the plates are made. For example, a very smooth material may require larger, flatter or more ribs to increase the rib contact area so that the plates do not spin too freely. Conversely, a rougher or tackier material dictates that smaller, more “pointed”, or fewer ribs be used in order to decrease the contact area so that the plates are not too difficult to rotate.

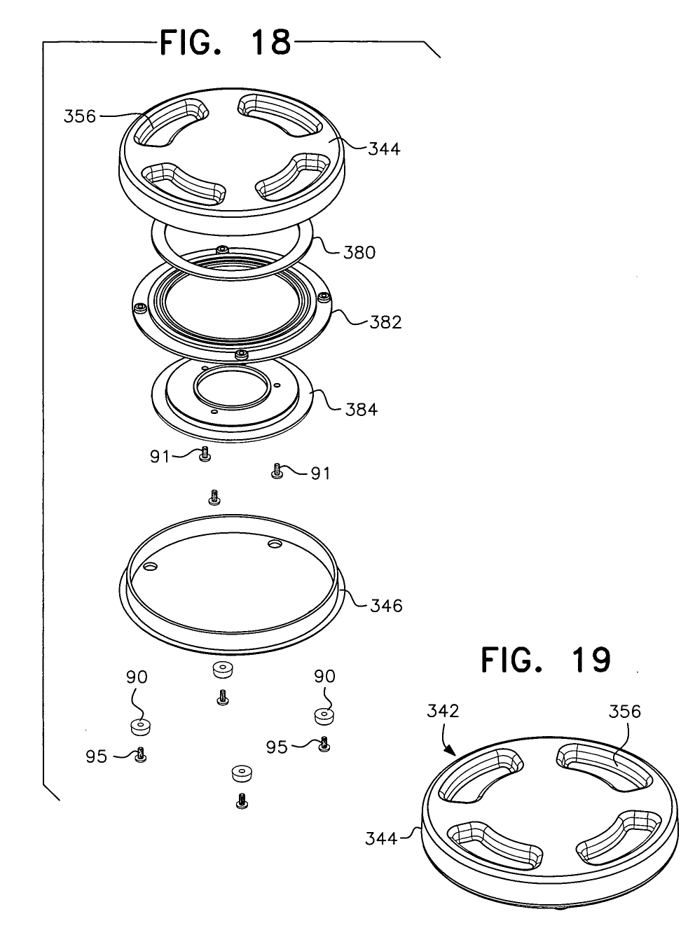

The inner ring 122 on the upper plate 84 has an upwardly extending rim 136 on its inner perimeter edge 138 and a plurality of apertures 140 passing from an upper surface 142 to a lower surface 144 of the inner ring 122. The upper plate 84 is secured to the upper trivet plate 44 by passing screws 91 (see FIG. 18) through the apertures 140 and into the threaded bores 61 of the upper trivet plate bosses 55. The rim 136 acts to help center the upper plate 84 with respect to the upper trivet plate 44 during this process, making assembly easier. The inner ring, perimeter ring, ribs and rim are preferably integral with one another and formed of molded plastic.

The upper plate 84 fits within the lower bearing plate 82 in a nested relationship in which the upper surface 128 of the perimeter ring 120 of the upper plate 84 engages with the lower ribbed surface 100 of the inner ring 92 of the lower bearing plate 82. When fully engaged and nested as shown in FIG. 14C, the lower ribbed surface 130 of the perimeter ring 120 of the upper plate 84 is substantially flush with the lower surface 110 of the perimeter ring 90 of the lower bearing plate 82. The flat upper surface 142 of the inner ring 122 of the upper plate 84, however, is higher than the adjacent ribbed upper surface 98 of the inner ring 92 of the lower bearing plate 82, creating a shoulder 150 that defines an outer diameter of the upper plate inner ring 122.

The washer 80 has a flat upper surface 151 with an inner diameter 152 that corresponds with the outer diameter of the shoulder 150 on the upper plate inner ring 122. When the turntable 50 is fully assembled with the washer 80 in position as shown in FIGS. 14A through 14E, the lower surface 154 of the washer 84 rests flat on the ribbed upper surface 98 of the inner ring 92 of the lower bearing plate 82, with the inner diameter 152 of the washer 80 abutting against the shoulder 150 of the upper plate 84. When assembled, therefore, the upper surface 142 of the inner ring 122 of the upper plate 84 is flush with the upper surface 151 of the washer 80. The washer 80 thus distributes and transfers weight placed on the upper trivet plate 44 from the upper plate 84 to the lower bearing plate 82, ensuring that the upper plate 84 is able to rotate relative to the lower bearing plate 82 without excessive friction, even when the trivet assembly is under the load of a heavy plant and pot. In turn, because the upper plate is secured to the upper trivet plate 44 by the fastening elements or screws 91 (see FIG. 18), the upper trivet plate 44 also rotates relative to the lower trivet plate 46. At the same time, the interfitting relationship of the plates as stacked upon one another in the plate bearing turntable 50 retains sufficient friction between the plates to prevent free spinning rotation of the trivet assembly 12 (which could overturn the plant).

The large trivet assembly 42 is preferably supported on rubber feet, generally designated by the reference numeral 90, as shown in FIGS. 15A-15E. The rubber feet are secured against the bottom of lower trivet plate 46 by screws 95. The rubber feet are generally cylindrical or frusto-conical with a through-passing aperture, generally designated by the reference numeral 170, extending from a flat top 172 to a flat bottom, generally designated by the reference numeral 174. As used in connection with the rubber feet, “top” and “bottom” are identified with respect to the positions of the feet when in use.

The aperture 170 in each foot 90 has two bore sections of different diameters, with the upper bore 176 having a smaller diameter than the lower bore 178. The upper bore 176 is concentric with the lower bore 178. The larger lower bore 178, which defines the flat bottom 174 as an annular rim 173, forms a pocket large enough in both width and depth to receive a screw head in a countersunk relationship with the rim 173. The rim 173 thus provides a non-scratching, frictional contact surface with wood, tile or other supporting surfaces upon which the trivet assembly may be placed.

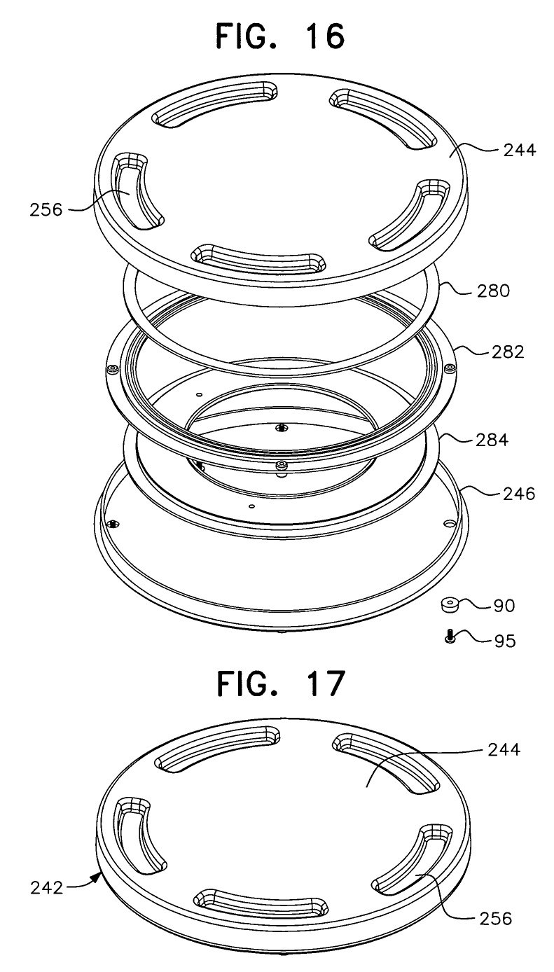

Exploded and assembled views of a medium trivet assembly according to the present invention are shown in FIGS. 16 and 17, respectively. Like the large trivet assembly, the medium trivet assembly includes an upper trivet plate, a lower trivet plate and an annular plate bearing turntable that provides rotational movement of the upper trivet plate relative to the lower trivet plate. The foregoing structures correspond with those already discussed in connection with the large trivet assembly and therefore a discussion thereof will not be repeated here. Reference numerals used to identify the corresponding components with respect to the large trivet assembly have been provided with an antecedent “2” since the dimensions of these components are not identical with those of the large trivet assembly. Their structure and function, however, are the same.

Exploded and assembled views of a small trivet assembly according to the present invention are shown in FIGS. 18 and 19, respectively. Like the large and medium trivet assemblies, the small trivet assembly includes an upper trivet plate, a lower trivet plate and an annular plate bearing turntable that provides rotational movement of the upper trivet plate relative to the lower trivet plate. The foregoing structures correspond with those already discussed in connection with the large trivet assembly and therefore a discussion thereof will not be repeated here. Reference numerals used to identify the corresponding components with respect to the large trivet assembly have been provided with an antecedent “3” since the dimensions of these components are not identical with those of the large trivet assembly. Their structure and function, however, are the same.

To assemble any of the small, medium or large trivet assemblies, the upper plate 84 is nested within the lower bearing plate 82 and the washer 80 is positioned on top of the lower bearing plate 82 and against the shoulder of the upper plate 84, as described above. Screws 91 are then inserted through the apertures 140 in the upper plate from the lower surface 144 to the upper surface 142 and screwed into the threaded bores 61 of the bosses 55 on the lower surface of the upper trivet plate 44. Once the screws 91 are tightened, the upper plate 84 is held in a fixed relationship with the upper trivet plate.

The rim 64 on the lower trivet plate 46 is then inserted inside the rim 60 of the upper trivet plate 44 while aligning the apertures 65 in the lower trivet plate 46 with the downwardly directed bosses 106 on the lower surface 110 of the lower bearing plate 82. Screws 95 are respectively inserted through the apertures 170 in a corresponding number of rubber feet 90, and then through the apertures 65 and into the bore 112 of the bosses 106 of the lower bearing plate 82. The screws 95 are tightened to secure the lower trivet plate in a fixed relationship with the lower bearing plate. The rubber feet 90 serve both a washer function with respect to the screws and also provide a secure, non-slip interface between the trivet assembly and a supporting surface.

As assembled, the lower bearing plate 82 and lower trivet plate 46 rotate with respect to the upper plate 84 and the upper trivet plate 44 along the interface between the ribbed lower surface 100 of the inner ring 92 of the lower bearing plate 82 and the flat upper surface of the perimeter ring 120 of the upper plate 84. The ribs reduce the bearing surface to facilitate rotation but nonetheless provide sufficient friction to prevent freely spinning rotation.

Being constructed of molded plastic, the components of the trivet assembly are impervious to moisture and will not corrode in damp environmental conditions. As compared with conventional ball bearings, the plate bearing turntable construction as described herein is simple and inexpensive in construction, with no maintenance required to sustain the rotational capability.

To obtain the interchangeable saucer capability of the trivet assembly in accordance with the present invention, the upper trivet plates of each of the trivet assemblies shown herein are provided with a centering and retaining mechanism 15 that includes both the outer edge of the trivet assembly itself and, preferably, one or more variously shaped and positioned pockets to receive correspondingly shaped protrusions on a plurality of saucers of different sizes. Representative saucer sizes and protrusion patterns are shown in the remainder of the drawings.

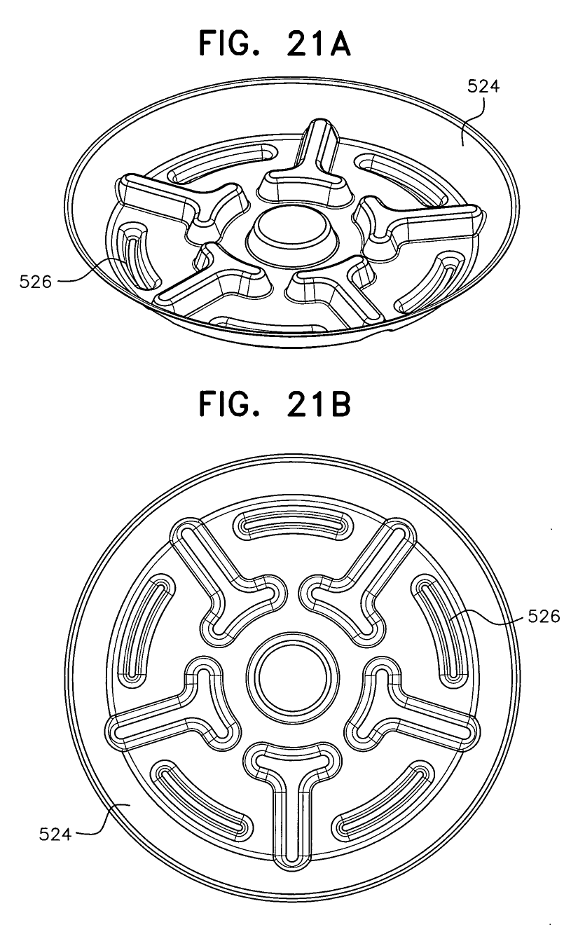

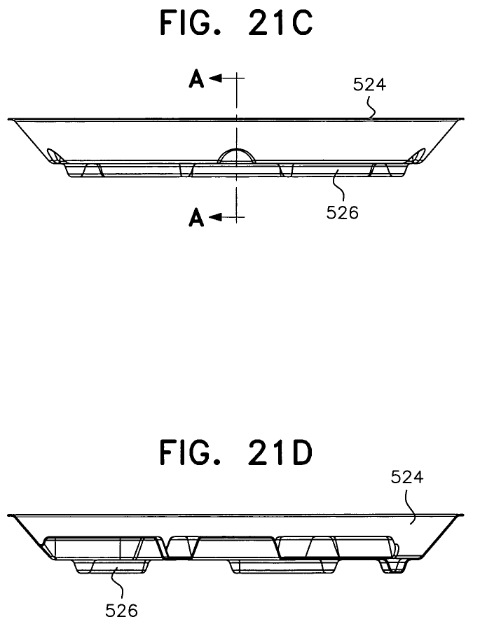

Specifically, a 6″ saucer 424 is illustrated in various views in FIGS. 20A-20D, a 10″ saucer 525 is illustrated in various views in FIGS. 21A-21D, a 14″ saucer 624 is illustrated in various views in FIGS. 22A-22D, and a 16″ saucer 724 is illustrated in various views in FIGS. 23A-23D.

As can be seen, the protrusions 426 on the bottom of the 6″ saucer 424 in FIGS. 20A-20D fit cooperatively within the pockets 356 in the upper trivet plate 344 of the small trivet assembly 342 (see FIGS. 18 and 19). The small trivet assembly 342 can also be used to center and retain an 8″ saucer having a construction like that shown in FIGS. 20A-20D by interlocking the protrusions on the 8″ saucer with the outer edge of the trivet assembly 342, such as shown in FIGS. 5 and 6.

The 10″ saucer 524 of FIGS. 21A-21D is made with protrusions 526 that fit within the pockets 256 of the upper trivet plate 244 of the medium trivet assembly 242 (see FIGS. 16 and 17). The medium trivet assembly 242 can also be used to center and retain a 12″ saucer having a construction like that shown in FIGS. 21A-21D by interlocking the protrusions on the 12″ saucer with the outer edge of the trivet assembly 242.

Finally, the protrusions 626 on the bottom of the 14″ saucer 624 in FIGS. 22A-22D fit cooperatively with the pockets 56 in the upper trivet plate 44 of the large trivet assembly 42 (see FIGS. 9A-9E). In addition, the protrusions 726 on the bottom of the 16″ saucer 724 in FIGS. 23A-23D interlock with the rim 60 of the upper trivet plate 44 of the large trivet assembly 42.

In each saucer design, the centering and retaining mechanism, by which the protrusions on the respective saucer are either captured within corresponding pockets formed in the trivet assembly or locked around the outer edge of the trivet assembly, effectively centers the saucer and secures it against side to side movement. In some cases, as with the large trivet assembly, the pockets formed in the trivet assembly may in themselves be sized and spaced to interlock with two different sizes of saucers for centering of each saucer on the top surface surface of the trivet assembly; such an assembly would then be able to interchangeably support three different saucers, two through interlocking of the protrusions with the various pockets and a third by locking the saucer protrusions over the outer edge of the trivet assembly.

Other saucer designs could, of course, also be used provided the trivet assembly was made with such designs in mind. The present invention is intended to include all such complementary trivet assembly and saucer designs that use a centering and retaining mechanism as disclosed herein.

The foregoing descriptions and drawings should be considered as illustrative only of the principles of the invention. The invention may be configured in a variety of shapes and sizes and is not limited by the dimensions of the preferred embodiment. Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. A rotatable plant stand for a potted plant comprising a rotatable trivet assembly and a saucer having at least one downwardly directed protrusion on a lower surface thereof, said trivet assembly including an upper trivet plate, a lower trivet plate and a plate bearing turntable positioned between said upper and lower trivet plates, said upper trivet plate having one or more pockets in an upper surface thereof to receive the protrusion on the lower surface of the saucer to secure the saucer on the upper trivet plate so as to prevent sideways movement thereof, said plate bearing turntable providing for rotational movement of said upper trivet plate relative to said lower trivet plate.

2. The rotatable plant stand as set forth in claim 1, wherein said plate bearing turntable includes at two bearing plates that are configured to allow rotation with sufficient friction to prevent freely spinning rotation.

3. The rotatable plant stand as set forth in claim 1, wherein said upper trivet plate includes a plurality of pockets in said upper surface, said plurality of pockets being spaced from one another and configured to receive at least different sets of protrusions as provided on two different types of saucers.

4. The rotatable plant stand as set forth in claim 3, wherein said plurality of pockets includes an annular channel in a central area of said upper trivet plate and a plurality of spaced pockets around a perimeter of said upper trivet plate.

5. The rotatable plant stand as set forth in claim 4, wherein a first saucer has an annular protrusion that is received within said annular channel and a second saucer has a plurality of spaced protrusions that are respectively received in said plurality of spaced pockets, said first and second saucers being of different sizes.

6. The rotatable plant stand as set forth in claim 1, wherein said plate bearing turntable includes a first bearing plate fastened to the upper trivet plate and a second bearing plate fastened to the lower trivet plate, said first and second bearing plates being rotatable with respect to one another on a shared bearing surface.

7. The rotatable plant stand as set forth in claim 6, wherein said plate bearing turntable further includes a washer that transfers weight placed on the upper trivet plate from the first bearing plate to the second bearing plate.

8. The rotatable plant stand as set forth in claim 7, wherein said first and second bearing plates are annular with each having an inner ring integrally formed with a perimeter ring, said first bearing plate inner ring being received within an open center area of said second bearing plate in a nested arrangement so as to be in abutment with said second bearing plate inner ring.

9. The rotatable plant stand as set forth in claim 8, wherein said first bearing plate inner ring is raised with respect to said first bearing plate perimeter ring such that said first bearing plate inner ring protrudes beyond an upper surface of said second bearing plate inner ring to define a shoulder when said first ring is nested within said second ring.

10. The rotatable plant stand as set forth in claim 9, wherein said washer is a flat ring that rests on said upper surface of said second bearing plate inner ring in abutment with said shoulder such that an upper surface of said washer is flush with an upper surface of said first bearing plate inner ring when said turntable is assembled.

11. The rotatable plant stand as set forth in claim 8, wherein said bearing surface is formed by an upper surface of said first bearing plate perimeter ring in engagement with a lower surface of said second bearing plate inner ring.

12. The rotatable plant stand as set forth in claim 11, wherein at least one of said engaging surfaces forming said bearing surface includes at least one raised rib concentric with said rings.

13. A rotatable trivet assembly for use with a potted plant supported in a saucer having a downwardly directed protrusion on a lower surface thereof, said trivet assembly comprising an upper trivet plate, a lower trivet plate and a plate bearing turntable, said upper trivet plate receiving the protrusion on the lower surface of the saucer to secure the saucer against sideways movement on the upper trivet plate, and said plate bearing turntable including first and second bearing plates each secured to one of the upper and lower trivet plates and having opposed surfaces in frictional engagement with one another to provide relative rotational movement of said upper trivet plate on said lower trivet plate.

14. The rotatable trivet assembly as set forth in claim 13, wherein said upper trivet plate includes a plurality of pockets in said upper surface, said plurality of pockets being spaced from one another and configured to receive at least different sets of protrusions as provided on two different types of saucers.

15. The rotatable trivet assembly as set forth in claim 14, wherein said plurality of pockets includes an annular channel in a central area of said upper trivet plate and a plurality of spaced pockets around a perimeter of said upper trivet plate.

16. The rotatable plant stand as set forth in claim 13, wherein said plate bearing turntable further includes a washer that transfers weight placed on the upper trivet plate from the first bearing plate to the second bearing plate.

17. The rotatable plant stand as set forth in claim 16, wherein said first and second bearing plates are annular with each having an inner ring integrally formed with a perimeter ring, said first bearing plate inner ring being received within an open center area of said second bearing plate in a nested arrangement so as to be in engagement with said second bearing plate inner ring.

18. The rotatable plant stand as set forth in claim 17, wherein said first bearing plate inner ring is raised with respect to said first bearing plate perimeter ring such that said first bearing plate inner ring protrudes beyond an upper surface of said second bearing plate inner ring to define a shoulder when said first bearing ring is nested within said second bearing ring.

19. The rotatable plant stand as set forth in claim 18, wherein said washer is a flat ring that rests on said upper surface of said second bearing plate inner ring and in abutment with said shoulder such that an upper surface of said washer is flush with an upper surface of said first bearing plate inner ring when said turntable is assembled.

20. The rotatable plant stand as set forth in claim 17, wherein said frictional engagement is between an upper surface of said first bearing plate perimeter ring in engagement with a lower surface of said second bearing plate inner ring.

21. The rotatable plant stand as set forth in claim 20, wherein at least one of said engaging surfaces includes at least one raised rib concentric with said rings.

22. A rotatable plant stand for a potted plant comprising a rotatable trivet assembly and one or more different sized saucers mountable on said trivet assembly by a centering and retaining mechanism that prevents sideways movement of each saucer relative to said trivet assembly, said trivet assembly including an upper trivet plate, a lower trivet plate and a plate bearing turntable to provide relative rotational movement of said upper and lower trivet plates.

23. The rotatable plant stand as set forth in claim 22, wherein said centering and retaining mechanism includes one or more pockets in an upper surface of said upper trivet plate to receive a corresponding protrusion on a lower surface of the saucer.

24. The rotatable plant stand as set forth in claim 22, wherein said centering and retaining mechanism includes a protrusion on a lower surface of the saucer that engages an outer edge of said trivet assembly.
